(19) United States
(12) Patent Application Publication
(10) Pub. No.: US 2011/0218984 A1
(43) Pub. Date: Sep. 8, 2011

(54) METHOD AND SYSTEM FOR SEARCHING FOR INFORMATION PERTAINING TARGET OBJECTS

(76) Inventors: Adi Gaash, Holon (IL); Ilan Simon, Tel Aviv (IL)

(21) Appl. No.: 13/128,250

(22) PCT Filed: Dec. 17, 2009
(86) PCT No.: PCT/US2009/068412

§ 371 Date: May 9, 2011

(30) Foreign Application Priority Data
Dec. 22, 2008 (IL) 196115

(51) Int. Cl. G06F 17/30

(52) U.S. Cl. 707/706; 707/769; 707/E17.108

(57) ABSTRACT

System and method of reducing complexity of a visual search for at least one target object, using at least one user device, comprising: obtaining an image of a target object creating least one target image, using the user device; receiving image data and metadata associated with the photographed target object from the user device; searching for the target object in at least one known objects database comprising the locations and identifying data of known objects to identify the target object; and retrieving information related to the identified target object. The known objects database is structured to allow visual search by partitioning general zones comprising known objects into sub zones, where the visual search is carried out in correspondence with the structure of the known objects database.

### FIELD OF THE INVENTION

The present invention relates generally to the field of systems, methods and search engines and more particularly, to systems, methods and search engines of searching for image data based input.

### BACKGROUND

An object search engine is designed to search for information that is associated with input visual images. To find content (either textual, visual or aural content) through data sources in a network such as the internet that is associated with the image, the image must first be identified by the engine or any other application.

Identification of the image may be carried out by various algorithms and methods known in the art such as the Computer Vision application and other algorithms enabling to search through images databases by translating the input and database images into content such as color tables of each pixel of the image, approximations of shapes is the image, shades and contrasts etc. The content of the input image is then compared to the content of each image in the database to identify the input image.

In cases of large databases containing a large amount of reference images, this process of searching can be extremely time consuming and may require high precision in order for the search to be effective.

Patent application no. EP1315102A2 (referred to herein after as “D1”), which is incorporated by reference herein in its entirety discloses a context-aware imaging device that includes an image capturing and present system enabling to photograph and present an image of a landmark; a context interpretation engine which generates contextual information relating to the landmark; and a context rendering module coupled to the context interpretation engine enabling to render the contextual information to the user of the imaging device. The context interpretation engine, according to D1, also comprises a location determination system the enables detecting the location and direction of the imaging device and enables using the location information to identify the landmark by identifying its location.

The problem with D1's method is that the device mainly used for sensing the location parameters are usually inaccurate and may often cause misidentification of the exact location of the landmark and therefore a misidentification of the image. This problem may increase in proportion to the density of landmarks in the area where the target landmark has been photographed, meaning that the more landmarks there are at a predefined area size—the more difficult and inefficient it may be to identify the exact landmark that was photographed.

### SUMMARY

The present invention, according to some embodiments thereof provides a system, a method and at least one object search engine for identifying a target object and retrieving information pertaining the identified target object in an optimized manner that allows reducing the complexity of the search and therefore the searching time, by structuring at least one known objects database according to the geographical distribution of known objects and using this structured database(s).

A target object may be any object such as a building, a site, a natural environment, a statue, a tourist site, a beach, a lake, and the like, that has a substantially identifiable geographical location.

According to some embodiments, a computer implemented method is provided, enabling to reduce complexity of a visual search for at least one target object, using at least one user device, which is a communication device enabling to photograph target objects, transmit data relating to the photographed target object and the location of the user device and communicate through at least one communication network.

The term “visual search” refers to searching through databases and data information that contain image based data of known objects, meaning that an image is represented by any image data known in the art (e.g. pixels coloring, image related parameters and the like), where the system enables receiving an image data and/or analyzing an image to output image data of one or more data types (e.g. various image parameters and search through data sources that have compatible image data of known objects.

According to some embodiments, the method may comprise photographing a target object creating at least one target image, using the user device; receiving image data and metadata associated with the photographed target object from the user device; searching for the target object in at least one known objects database comprising the locations and identifying data of known objects to identify the target object; and retrieving information related to the identified target object.

According to some embodiments, the known objects database may be structured according to the locations of the known objects to allow visual searching therethrough, wherein the database is associated with at least one geographical general zone, each general zone may be partitioned into sub zones, wherein the size and shape of each sub zone in each general zone may be defined according to the geometrical distribution of known objects in the general zone (e.g. the densities of the known objects).

The visual search may correspond to the structure of the objects database, using the received metadata that includes the location data of the user device to identify at least one sub zone of a general zone in the at least one objects database in which the target object is searched.

According to some embodiments, the visual search through the at least one known objects database may further include analyzing the image data of the target object to deduce image parameters and comparing these parameters with corresponding parameters of known objects stored in the at least one known objects database.

The search may further include: assigning a proximity value to each known object in at least one of the sub zones in the general zone that is identified according to the received location data of the user device, wherein the proximity value indicates a calculated valuation of the probability for the known object to be the target object, according to a predefined valuation algorithm including at least some parameters extracted from the received metadata; comparing the proximity values of all known objects of at least one of the sub zones in the general zone.

The target object may be the known object that has the best proximity value (highest or lowest—depending upon predefined calculation algorithms and definitions).

The searching for the target object, according to these embodiments, may be carried out in a parallel manner, wherein the calculations and comparison of proximity values of known objects of each sub zone in the general zone may be carried out substantially simultaneously in all sub zone of the identified general zone.

Each sub zone may be of a polygonal shape different sub zones in the same general zone may have different polygonal shapes as well as different size (e.g. areas) according to the geographical distribution of the known objects in each part of the general zone.

The searching method may further include analyzing the metadata of each target object to facilitate in identifying the location coordinates of the user device and the photographing direction vector indicating the direction of photographing, wherein the metadata includes the location of the user's device and the direction of photographing of the target image. A single sub zone to be searched through may be identified by identifying a first sub zone indicating the location of the user device and a second sub zone, wherein the proximity values may be assigned to known objects in the first and the second identified sub zones. The proximity values calculations may include the distance between the location of user device and the relation between the direction of the photographing vector and the known object's location, wherein the best proximity value is assigned to the known object that is closest to the location of the user device, along the photographing direction vector.

The method may further comprise transmitting the retrieved information pertaining the identified target object to the user device, once the target object is identified and information relating to the identified target object is retrieved from at least one information data source; and presenting the retrieved information through the user device.

According to some embodiments, a computer implemented method for structuring a database of known objects is also provided, enabling to structure the known object database according to geographic locations of the known objects, for enabling visual searches through the database. According to these embodiments, the method may include defining general zones, according to predefined rules; and portioning each general zone into sub zones, according to the distribution of known objects in the general zone, where, again, the size and shape of each sub zone is determined according the distribution of the known objects.

The rules according to which the general zones are defined may include the geographical boundaries of each area, and/or the distribution of receivers and transmitters of the at least one communication network used for transmitting the image data and metadata.

According to some embodiments, a system of reducing complexity of visual searching of at least one target object and searching for information pertaining the target object is further provided. The system may comprise at least one object search engine and at least one user device, wherein the user device is a communication device enabling to photograph images, transmit and store data pertaining the photographed images and the location of the device and communicate with the at least one object search engine through at least one communication network.

The at least one object search engine may enable receiving image data and metadata comprising location data of the photographed target object from the at least one user device, processing the received data, searching in at least one objects database comprising known objects to identify the target object of the transmitted image and retrieving information pertaining the identified target object. The at least one objects database may be structured according to the locations of the known objects to allow search therethrough, wherein the database is associated with at least one geographical general zone, each general zone is partitioned into sub zones, wherein the size and shape of each sub zone in each general zone is defined according to the distribution of known objects in the general zone, and wherein the visual search for the target object through the object database corresponds to the structuring of the objects database, using the received metadata that includes the location data of the user device to identify at least one sub zone of a general zone in the at least one objects database in which the target object is searched.

The visual search through the at least one known objects database may further include analyzing the image data of the target object to deduce image parameters and comparing these parameters with corresponding parameters of known objects stored in the at least one known objects database.

According to some embodiments, a multiplicity of search engines may enable searching for the target object in a parallel manner, wherein the calculations and comparison of proximity values of known objects of each sub zone in the general zone are carried out substantially simultaneously in all sub zone of the identified general zone.

The user device may be any communication device that allows photographing and creating files comprising image data and metadata, that may also enable locating the device. For example, the user device may comprise: a photography unit enabling a user to obtain target objects' images by photographing target images and store images data; a transmission and receiving unit enabling to transmit and receive data to and from the at least one server; and a presentation unit enabling to present information relating to identified target objects.

The user devices may be cellular mobile phones, laptops, PDA devices and the like as known in the art.

The at least one user device may further comprise a positioning unit (e.g. a Global Positioning System) enabling to locate the positioning of the user device and a direction vector, store and analyze the location data, wherein the direction vector indicates the photographing direction from the user device to the target object.

The system may further comprise at least one communication services provider, enabling to receive signals from the user device and translate the received data into image data, user data and location data, where the location of the user device may be carried out thereby.

The system may further comprise at least one server enabling to operate the at least one object search engine and communicate with at least one user device through the at least one communication network. The at least one server may comprise: the at least one object search engine; an information retrieval engine, enabling to retrieve content information pertaining the identified target object from at least one information data source; a transmission-receiving module enabling to receive image data and metadata including the location data of the user device from the at least one user device and to transmit information data to the at least one user device, wherein the information data includes the retrieved content relating to the target image.

### BRIEF DESCRIPTIONS OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a block diagram schematically illustrating a system for searching information relating to a target object image, according to some embodiments of the invention;

FIG. 2 is a schematic illustration of database organization structure according to zones division of a general area according to density of objects and location parameters of a user device for narrowing of the scope of search objects, according to some embodiments of the invention;

FIG. 3 is a flowchart, schematically illustrating a method for structuring a known objects database, according to some embodiments of the invention;

FIG. 4 is a flowchart schematically illustrating a method for searching information relating to a target object image, according to some embodiments of the invention; and

FIG. 5 is a flowchart schematically illustrating a method for searching information relating to a target object image, according to other embodiments of the invention.

The drawings together with the description make apparent to those skilled in the art how the invention may be embodied in practice.

### DETAILED DESCRIPTIONS

While the description below contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

The present invention, in some embodiments thereof, provides a system 1000, a method and an object search engine 121, for searching and identifying a target object 10 photographed by a user in an optimized manner that facilitates in reducing the complexity of the search and hence reduces the search time dramatically. The target object 10 may be photographed by a user, using a user device 110, which is also a communication device such as a mobile phone with camera application, a personal digital assistant (PDA) or any other communication device which includes means for photographing target objects 10, which may allow creating an image data of the photographed target object.

The system 1000, according to some embodiments thereof, may enable a user to photograph an object 10 in a location (e.g. a site) such as a museum, a building, a sculpture etc., transmit the image data of the photographed picture to a main server 120, where the target object 10 may be identified according to location and image data transmitted from the user device 110, and information pertaining the object 10 may be searched by the server 120 transmitted to the user device 110 and presented to the user. This may enable users to online search for information relating to objects they view in places where the user is currently located to carry out the photographing of the target object 10 of which they require information.

The invention, according to some of its embodiments, may enable reducing the amount of reference known objects' data in which the target object is searched (e.g. by reducing the number of known objects). The reduction may be carried out by identifying an approximated general zone in which the target object is located, by locating of the user device by which the target object was photographed at the time it was photographed, where the search for identifying of the target object may be carried out only for known objects located in the identified zone.

The target objects 10 may be any object, which can be located such as buildings, landscapes, monuments, cities, streets, parks, stadiums, sites and the like.

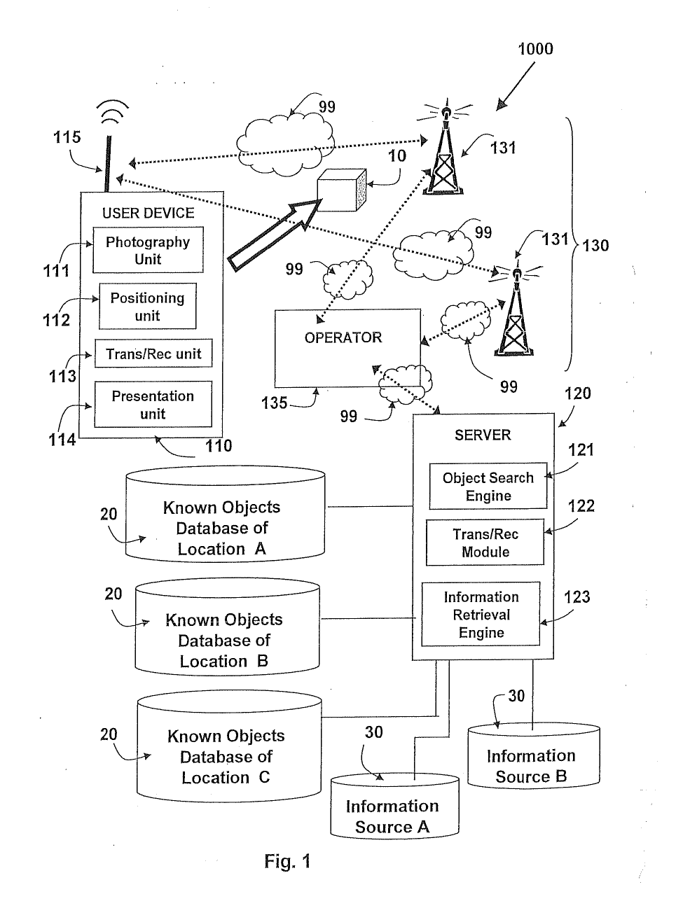

FIG. 1 is a block diagram schematically illustrating a system 1000 for optimizing searches of at least one target object 10, according to some embodiments of the invention.

According to these embodiments, as illustrated in FIG. 1, the system 1000 may comprise: at least one user device 110; at least one server 120; and at least one communication services provider 130.

According to some embodiments of the invention, the user device 110 may be a communication device such as a mobile phone including a photography unit 111 such as a digital camera to enable the user to photograph target objects 10, as well as to enable creating and transmitting image data of the photographed target object and location data relating to the location of the user device 110 and/or the location of the target object 10 in the image.

According to some embodiments of the invention, the user device 110 may further comprise a positioning unit 112 such as a global positioning system (GPS) or any other positioning system known in the art that enables locating the location of the user device 110 and some other features relating to the photographing such as, for instance, the direction of photographing, the zoom position and the like.

According to some embodiments of the invention, the user device 110 may further comprise a transmission/receiving unit 113 enabling to receive data and translating signals into data and to transmit image and location data, via at least one communication network 99 (e.g. wireless network(s) such as GSM, the internet, and the like and through any predefined communication protocol(s) known in the art.

According to some embodiments of the invention, the user device 110 may further comprise a presentation unit 114, which may enable presenting information such as content information (textual, aural and/or visual) relating to the target object 10.

According to some embodiments of the invention, the server 120 may enable receiving the image and metadata from the user device 110, processing the received data to identify the target object 10, construct a search query for searching information pertaining the identified object and retrieve information (any known in the art content) pertaining the identified target object 10, accordingly.

The communication service provider 130 may be any provider enabling to receive data as signals or in any other format from the user devices 110 and transmit the data (e.g. also through mobile communication network(s) 99) to the at least one server 120.

According to some embodiments of the invention, the metadata transmitted may include, for example, the location of the user device 110, the direction of photographing, the zoom position of the camera at the time of photographing the target object 10, time parameters and image data of the photographed object 10.

For example, as illustrated in FIG. 1, the service provider 130 may be a cellular communication provider, where an operator 135 enables receiving and processing signals arriving from a multiplicity of user devices 110 through a multiplicity of receivers and transmitters 131 located in a multiplicity of locations, allowing to locate the general zone 50 in which the user device 110 transmits from by identifying the receiver 131 (where the location of the receiver 131 is known), as known in the art.

According to some embodiments of the invention, as illustrated in FIG. 1, the server 120 may comprise: an object search engine 121; a transmission/receiving module 122; and an information search engine 123.

According to some embodiments of the invention, the server 120 may enable accessing one or more known objects databases 20 comprising information relating to known objects 10′ (such as known museums, sites, buildings, streets etc.), where the information may include the name identifying the object, the location of the known object and the like. The known objects databases 20 may be structured and structured according to the distribution of known objects (e.g. the density of objects) in each predefined general zone, as will be further elaborated.

According to some embodiments of the invention, the server 120 may additionally enable access to one or more information data sources 30 enabling to search and retrieve information relating to identified objects (e.g. through queries, as known in the art).

The objects databases 20 may be indicated according to the general zones 50 and sub zones 55 divisions, where the sub zones 55 of each general zone 50 may be previously defined and where the server 120 may allow updating these sources 20 regarding new known objects 10′ and their locations and/or regarding updates locations of previously known objects 10′.

The objects databases 20 may be stored within the server(s) 120, in remote computerized systems or both.

According to some embodiments of the invention, the object search engine 121 may enable operating one or more search algorithms enabling to search through the known objects databases 20 for a known object 10′ to find a match with the target object 10, according to predefined rules involving the metadata transmitted, in order to identify the target object 10. objects database

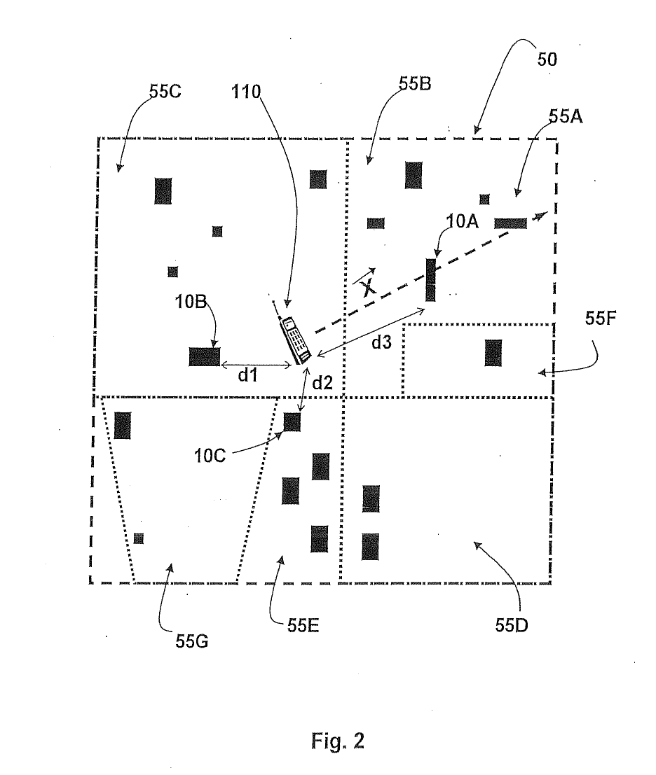

The object search engine 121 may reduce the complexity of the object search by structuring the known objects database(s) 20 by, for example, partitioning areas (e.g. geographical areas) into general zones 50 (e.g. according to the locations of antennas 131 for receiving mobile devices' signals) and by partitioning each general zone 50 into sub zones 55, as illustrated in FIG. 2 and then allowing to search through the general zone 50 that corresponds to the location of the user device 110 included in the metadata transmitted by the user. The division of each general zone 50 into sub zones 55 may be carried out according to the distribution of known objects 10′ within the general zone 50 relating to the densities of known objects 10′ in each part of the general zone 50.

According to some embodiments of the invention, as illustrated in FIG. 2, areas within the general zone 50 of higher density of known objects 10′ may be partitioned into more sub zones 55 than areas of lower density of known objects 10′. The size and shape of each sub zone 55 may vary, where each sub zone may have a shape and a size that corresponds to the distribution (locations) of the known objects 10′ therein. The sub zones 55 may have polygonal shape(s) of various numbers of sides.

According to some embodiments of the invention, as illustrated in FIG. 1 and FIG. 2, the user may photograph a target object 10 located in a first sub zone 55A, while the user device 110 (and the user) is located in a second sub zone 55C, which may or may not be adjacent to one another. In other cases, the user device 110 and the target object 10 may be located in the same sub zone 55. To identify the location of the target object 10 there may be additional information required other than just the location of the sub zone 55C in which the user device 110 is located. Accordingly, the metadata sensed and transmitted by the user device 110 and/or by the receivers 131 detecting the signals from the user device 110, may further include a photography direction vector “X” indicating the trajectory direction from the user device 110 towards the target object 10. The location of the user device 110 and the direction vector X may be included in the location data transmitted to the server 120. Additional information such as the zoom position may also be analyzed to further facilitate in identifying the target object 10.

To identify the known object 10′A that is most likely to be the target object 10 (referred to hereinafter as “potential known object”), the object search engine 121 may identify the general zone 50 in which the user device 110 is located (e.g. through the location data transmitted), a first sub zone 55C, in which the user device 110 is located and then calculate the sub zone 55A, in which the target object 10 is located by identifying the sub zone 55A in which a first known object 10′A is located. In this way, while other known objects 10′B and 10′C may be closer to the location of the user device 110, the direction vector X allows selecting a more accurate sub zone 55A in which to search. Additionally, according to some embodiments of the invention, the closest known object 10′A situated along the photography direction vector X may be identified by the searching algorithm as the target object 10.

This may prevent searching in sub zones 55C or 55G that include known objects 10′B or 10′C that are distant from the user device 110 in distances d1 or d2 that are shorter than the distance d3 between the known object 10′A that is situated along the direction vector X and the user device 110.

Alternatively, the closest known object 10′A situated along the photography direction vector “x” may only define the sub zone 55A in which the target object 10 may be searched by the object search engine 121, where image data including other identifying data may enable final identification such as, for example, the image data may be analyzed to produce image features of the target object 10 that may then be compared with corresponding features of the image data of the target object 10′ transmitted to the server 120.

For example, image processing algorithms may receive the image data of the target object 10, process it to produce parameters as the features identifying the target image and compare these feature with corresponding features of known object's 10′ images for all known objects 10′ that are located within the sub zone 55A in which the closest known object 10′A was identified. A match between the features and/or an approximated resemblance between the images' features may be defined in the system 1000 as identification of the target object 10.

Alternatively, the object search engine 121 may carry out a parallel search enabling to search through all sub zones 55 of the identified general zone 50 (identified by using the location data in the metadata that was transmitted) substantially simultaneously, using any known in the art searching technique, depending upon the transmitted metadata available pertaining the target object 10.

According to some embodiments of the invention, the searching technique may include assigning an “proximity value” (PV) to each known object 10′ in each sub zone 55 of the identified general zone 50, where the PV may be calculated according to any predefined calculation and function relating and including parameters indicated in the transmitted meta data (the location of the user device 110, the timing parameters, the photographing direction etc.). The PV assigned to each known object 10′ in each sub zone 55 may indicate the probability that the known object 10′ is the target object 10. The known object 10′ of the best (highest or lowest—depending on the definitions of the calculation) PV may be regarded by the object search engine 121 as the identified target object 10.

According to some embodiments of the invention, to reduce and optimize the calculation time, the calculation of the PVs of the known objects 10′ in each sub zone 55 may be carried out in a parallel manner through all the sub zones 55, where the object search engine 121 may enable operating parallel search algorithms to assign the PVs to all known objects 10′ in each sub zone 55 and compare the PVs of all known objects 10′ in each sub zone 55 to find the potential known object 10′ in each sub zone 55, which is the known object 10′ of each sub zone 55 that has the best (e.g. highest) PV in each sub zone 55. The object search engine 121 may then simply compare the PVs of all potential known objects 10′ to define the potential known object 10′ with the best (e.g. highest) PV as the target object 10.

Once the target object 10 has been identified, the information retrieval engine 123 in the server 120 may automatically generate a query to allow searching for any content information relating to the identified target object 10 in at least one information data source 30, according to the identified target object 10 and predefined query rules (e.g. the construction of a text query starting with the name of the identified target object 10 and then the location name).

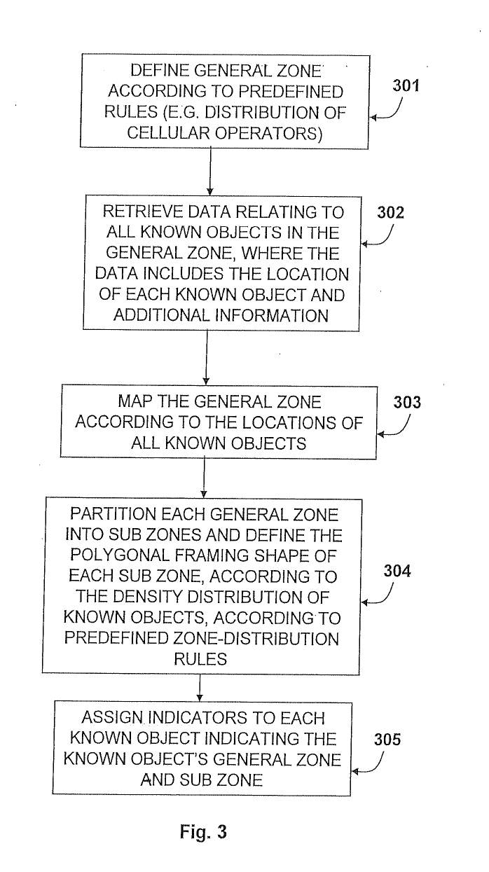

FIG. 3 is a flowchart, schematically illustrating a method for structuring the at least one known objects database 20, according to the geographical distribution of the known objects 10′, according to some embodiments of the invention.

According to these embodiments, the structuring method may comprise:

Defining general zones 50, according to predefined rules 301;

Retrieving data relating to the known objects 302 including, for example, the location and name of each known object 10′;

Mapping each general zone 50 according to the location of each known object 10′ in the general zone 303;

partitioning each general zone 50 into sub zones 55, according to the distribution of the location of all known objects 10′ in the general zone 50 and define the polygonal shape that frames each sub zone 55, according to the distribution and other predefined zone-distribution rules 304; and

Assign indicators to each known object—indicating the known object's general zone and sub zone 305.

According to some embodiments of the invention, the information relating to each known object 10′ that is retrieved (see step 302) may include, for example, the name of the known object (e.g. “The Eiffel Tower”, “The National Gallery of NY”, “The Statue of Liberty”, etc.), the name of its geographical location, other names for the object 10′, its address, etc.). this information and the location information may be stored in the known objects database 20 along with the indicators, indicating the object's 10′ general and sub zones.

According to some embodiments of the invention, the size and shape of each sub zone 55 may be determined according the distribution of the known objects 10′.

According to some embodiments of the invention, the predefined rules according to which the general zones 50 are defined may include the geographical boundaries of each area (e.g. the country, the city etc) and/or the distribution of receivers and transmitters 131 of the at least one communication network 99 used for transmitting the image data and metadata.

According to some embodiments of the invention, the object search engine 121 may enable updating the at least one known objects database 20 regarding updated locations of new known objects 10′ and regarding new known objects 10′.

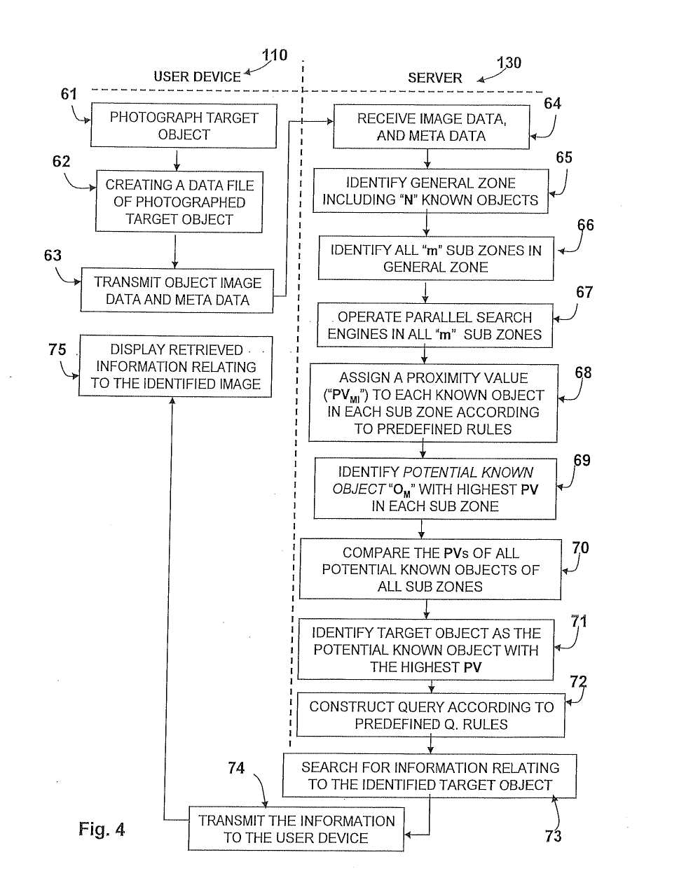

FIG. 4 is a flowchart, schematically illustrating a method for identifying a target object 10 and retrieving information pertaining thereto, according to some embodiments of the invention. According to these embodiments, the method comprises:

Obtaining an image of a target object 61, e.g. by using the photography unit 111 in the user device 110;

Creating a data file including the image data and the metadata 62;

Transmitting the image and metadata to the server 63, where steps 61-63 may be carried out through the user device 110;

Receiving the transmitted data 64 (carried out by the server 120);

Identifying the general zone 65 of the target object 10, according to the location data included in the metadata that has been transmitted;

Identifying the number of sub zones “m” in the identified general zone 66 and the division for sub zones 55;

Operating parallel search in all m sub zones simultaneously 67;

Assigning proximity values (PVs) to each known object 10′ in each sub zone 68 by applying any predefined function and/or algorithm to calculate the PV of each known object 10′;

Identifying the potential known object “Om” of each sub zone 69;

Compare the PVs of all potential known objects 10′ of the sub zones 70;

Identify the known object 10′ that is the identified target object as the potential known object 10′ of the highest PV 71;

Construct a search query for searching for content information relating to the identified target object 10, according to the identification details of the target object 10 in the known objects' data source 20 and according to predefined query rules (which enable the construction of the query) 72;

Searching for the related information through at least one information data source 73, using the constructed query;

Transmitting the retrieved information relating to the identified target object that was found to the user device 74; and

Displaying the retrieved information 75, through the user device 110.

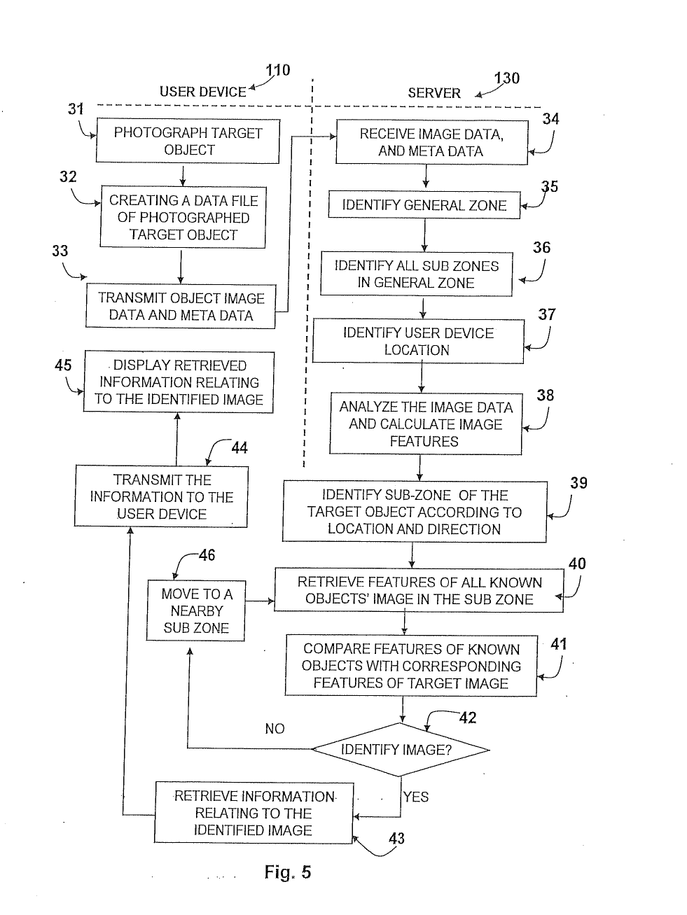

FIG. 5 is a flowchart schematically illustrating a method for identifying a target object 10 and searching for information relating pertaining thereto according to other embodiments of the invention.

According to these embodiments, the method may comprise:

Obtaining an image of a target object 31, e.g. by using the photography unit 111 in the user device 110;

Creating a data file comprising the location data and the image data 32;

Transmitting the data to the server 33 (carried out through the user device 110);

Receiving the transmitted data 34 (carried out by the server 120);

Identifying the general zone 35 of the target object 10, according to the received location data;

Identifying all sub zones 55 of the identified general zone 36;

Identifying location and thereby sub zone of the user device 37;

Analyze the image data of the target image 10 to calculate at least one feature of the image 38;

Identifying the sub zone 55 of the target object 39, according to the identified location and/sub zone 55 of the user device 110 and according to the photography direction vector X;

Retrieving all features and other information of all the known objects in the identified sub zone 55 where the target object is likely to be 40;

Comparing features of the target image with corresponding features of the known objects of the sub zone 41;

If the target object's 10 image features match the corresponding of one of the known objects 10′ in the sub zone 55—the matching known object 10′A is defined as the identified target object 42;

Retrieving information pertaining to the identified target object 43 (e.g. from the information data source(s) 30);

Transmitting the retrieved information to the user device 44; and

Presenting the transmitted information in the user device 45.

According to some embodiments of the invention, as illustrated in FIG. 4, if the image is not identified 42, meaning, for example, if the features of the target image do not match to any of the corresponding image features of any of the known objects 10′ of the identified sub zone 55—another nearby (adjacent) sub zone 55 may be searched 46 where steps 40-45 may be repeated for various sub zones 55 in the general zone 50 until a match is found or until another stopping condition is fulfilled.

The information retrieved pertaining the identified target object 10 may be any content format known in the art and/or any combination of formats, which can be presented by the user device 110. For example, the content of the information may be textual, aural, visual etc. Additionally, the format of transmission and content presentation and storage may be of any kind known in the art, that the user device 110 and/or server 120 can communicate with and read, such as Emails, SMS (short messaging service), MMS (multimedia Messaging Service), VoIP (voice over interne protocols) and the like.

According to embodiments, the objects search engine 121 may be operated by a client application, which may be installed in a remote computerized system enabling to receive the image data, the location data and any other metadata from the user device 110, process the received data to identify the object 10 by searching through the at least one known objects database 20 and search for information relating to the identified object 10 through the at least one information source 30.

The client application may be a desktop application installed users' computerized devices such as the users devices 110.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

1. An object search engine enabling visual searching for a target object in at least one known objects database, wherein the known object search engine enables receiving image data and metadata comprising location data of a target object from at least one user device, processing the received data, searching in at least one known objects database comprising known objects related information to identify the target object,
wherein the at least one objects database is structured according to the locations of the known objects to reduce complexity of a search therethrough, wherein the database is associated with at least one geographical general zone, each general zone is partitioned into sub zones, wherein the size and shape of each sub zone in each general zone is defined according to the distribution of known objects in the general zone, and
wherein the search for the target object through the object database corresponds to the structuring of the objects database, using the received metadata that includes the location data of the user device to identify at least one sub zone of a general zone in the at least one objects database in which the target object is searched.

2. The search engine of claim 1, wherein the visual search through the at least one known objects database further includes analyzing the image data of the target object to deduce image parameters and comparing these parameters with corresponding parameters of known objects stored in the at least one known objects database.

3. The search engine of claim 1, wherein the search further includes:
assigning a proximity value to each known object in at least one of the sub zones in the general zone that is identified according to the received location data of the user device, wherein the proximity value indicates a calculated valuation of the probability for the known object to be the target object, according to a predefined valuation algorithm including at least some parameters extracted from the received metadata;
comparing the proximity values of all known objects of at least one of the sub zones in the general zone,
wherein the target object is the known object that has the best proximity value.

4. The search engine of claim 3, further enables searching for the target object in a parallel manner, wherein the calculations and comparison of proximity values of known objects of each sub zone in the general zone are carried out substantially simultaneously in all sub zone of the identified general zone.

5. The search engine of claim 1, wherein the metadata of each target object further comprises other sensor data,
wherein the search through the known objects' database further relates to the sensor data and wherein the known objects' data is compatible to the image data and sensor data.

6. The search engine of claim 5, wherein the sensor data is at least one of: aural data and textual content data.

7. A computer implemented method of reducing complexity of a visual search for at least one target object, using at least one user device, which is a communication device enabling to obtain images of target objects, transmit data relating to the target object and the location of the user device and communicate through at least one communication network, the method comprising:
obtaining an image of a target object creating at least one target image, using the user device;
receiving image data and metadata associated with the target object from the user device;
searching for the target object in at least one known objects database comprising the locations and identifying data of known objects to identify the target object; and
retrieving information related to the identified target object,
wherein the known objects database is structured according to the locations of the known objects to allow visual search therethrough, wherein the database is associated with at least one geographical general zone, each general zone is partitioned into sub zones, wherein the size and shape of each sub zone in each general zone is defined according to the distribution of known objects in the general zone, and
wherein the visual search corresponds to the structuring of the objects database, using the received metadata that includes the location data of the user device to identify at least one sub zone of a general zone in the at least one objects database in which the target object is searched.

8. The method of claim 7, wherein the visual search through the at least one known objects database further includes analyzing the image data of the target object to deduce image parameters and comparing these parameters with corresponding parameters of known objects stored in the at least one known objects database.

9. The method of claim 7, wherein the search further includes:
assigning a proximity value to each known object in at least one of the sub zones in the general zone that is identified according to the received location data of the user device, wherein the proximity value indicates a calculated valuation of the probability for the known object to be the target object, according to a predefined valuation algorithm including at least some parameters extracted from the received metadata;
comparing the proximity values of all known objects of at least one of the sub zones in the general zone,
wherein the target object is the known object that has the best proximity value.

10. The method of claim 9, wherein searching for the target object is carried out in a parallel manner, wherein the calculations and comparison of proximity values of known objects of each sub zone in the general zone are carried out substantially simultaneously in all sub zone of the identified general zone.

11. The method of claim 7, wherein each sub zone is of a polygonal shape.

12. The method of claim 7, further comprising analyzing the metadata to identify the location coordinates of the user device and a direction vector indicating the direction of image obtainment, wherein the metadata includes the location of the user's device and the direction vector,
wherein a single sub zone to be searched through is identified by identifying a first sub zone indicating the location of the user device and a second sub zone,
wherein proximity values are assigned to known objects in the first and the second identified sub zones,
wherein the proximity values calculations include the distance between the location of user device and the relation between the direction of the obtainment vector and the known object's location,
wherein the best proximity value is assigned to the known object that is closest to the location of the user device, along the direction vector.

13. The method of claim 7, wherein the receiving of the location and image data in the metadata, the searching of the target object identification and the retrieving of information pertaining the identified target object are carried out by at least one server that enables communicating with a multiplicity of user devices, processing of data and communicating with images data sources and information data sources,
wherein the objects databases provide locations and identification data of known objects associated with general and sub zones, and the information sources provide information of objects.

14. The method of claim 7, further comprising:
transmitting the retrieved information pertaining the identified target object to the user device, once the target object is identified and information relating to the identified target object is retrieved from at least one information data source; and
presenting the retrieved information through the user device.

15. A computer implemented method for structuring a database of known objects, according to geographic locations of the known objects, for reducing complexity of visual searches through the database, enabling a user to transmit image data and metadata relating to a target object, using a user device that enables communication through at least one communication network,
the method includes:
defining general zones, according to predefined rules;
partitioning each general zone into sub zones, according to the distribution of known objects in the general zone;
wherein the size and shape of each sub zone is determined according the distribution of the known objects.

16. The method of claim 15, wherein the rules according to which the general zones are defined, include the geographical boundaries of each area.

17. The method of claim 16, wherein the rules according to which the general zones are defined, further include the distribution of receivers and transmitters of the at least one communication network used for transmitting the image data and metadata.

18. The method of claim 15, wherein an object search engine enables updating the at least one known objects database regarding updated locations of new known objects and regarding new known objects.

19-31. (canceled)
